(19) United States
(12) Patent Application Publication
(10) Pub. No.: US 2024/0291633 A1
(43) Pub. Date: Aug. 29, 2024

(54) VERIFICATION OF TRUSTWORTHINESS OF AGGREGATION SCHEME USED IN FEDERATED LEARNING

(71) Applicant: International Business Machines Corporation, Armonk, NY (US)

(72) Inventors: Giulio Zizzo, Dublin (IE); Stefano Braghin, Dublin (IE); Ambrish Rawat, Dublin (IE); Mark Purcell, Naas (IE)

(21) Appl. No.: 18/113,219

(22) Filed: Feb. 23, 2023

(51) Int. Cl. H04L 9/00; G06N 3/098

(52) U.S. Cl. CPC H04L 9/008; G06N 3/098

(57) ABSTRACT

A computer-implemented method, system and computer program product for verifying the trustworthiness of an aggregation scheme utilized by an aggregator in the federated learning technique. A bit mask is received from each client used for training a machine learning algorithm using the federated learning technique. Such a bit mask contains values of ones and zeros, where a value of one indicates that the updated parameter of the global model corresponds to a parameter used by the local model trained on the client and a value of zero indicates that is not the case. These bit masks, which are encrypted, may then be combined using a homomorphic additive encryption scheme into a mask containing a matrix of values. If the mask contains a matrix of values of only the value of one, then the aggregator is deemed to be trustworthy. Otherwise, the aggregator is deemed to be untrustworthy.

### TECHNICAL FIELD

The present disclosure relates generally to federated learning, and more particularly to the verification of the trustworthiness of an aggregation scheme used in federated learning.

### BACKGROUND

Federated learning (also known as collaborative learning) is a machine learning technique that trains an algorithm across multiple decentralized edge devices or servers holding local data samples without exchanging them. This approach stands in contrast to traditional centralized machine learning techniques where all the local datasets are uploaded to a server as well as in contrast to classical decentralized approaches which often assume that local data samples are identically distributed.

### SUMMARY

In one embodiment of the present disclosure, a computer-implemented method for verifying trustworthiness of an aggregation scheme used in federated learning comprises receiving a bit mask from each of a plurality of clients used for training a machine learning algorithm using the federated learning, where the bit mask indicates which parameters of a global model computed by an aggregator using the federated learning correspond to parameters used by a local model trained on a client. The method further comprises combining the bit masks received from the plurality of clients using a homomorphic additive encryption scheme into a mask containing a matrix of values. The method additionally comprises sending the mask to each of the plurality of clients to be analyzed by each of the plurality of clients, where the verification of the trustworthiness of the aggregation scheme used in the federated learning by the aggregator is determined based on the matrix of values.

Other forms of the embodiment of the computer-implemented method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 illustrates an example of the bit masks generated by the clients to indicate which of the updated parameters of the global model correspond to the parameters used by the local model trained on the client in accordance with an embodiment of the present disclosure;

FIG. 3 illustrates an example of a mask generated by the verification system containing a matrix of values of only the value of one in accordance with an embodiment of the present disclosure;

FIG. 4 illustrates an example of a mask generated by the verification system containing a matrix of values that includes one or more values besides the value of one in accordance with an embodiment of the present disclosure;

FIG. 5 is a diagram of the software components used by the verification system to verify the trustworthiness of the aggregation scheme used by the aggregator in accordance with an embodiment of the present disclosure;

FIG. 6 illustrates an embodiment of the present disclosure of the hardware configuration of the verification system which is representative of a hardware environment for practicing the present disclosure;

FIG. 7 is a flowchart of a method for identifying which updated parameters of the global model correspond to the parameters used by the local models trained on the clients in accordance with an embodiment of the present disclosure; and

FIG. 8 is a flowchart of a method for verifying the trustworthiness of the aggregation scheme used in the federated learning technique in accordance with an embodiment of the present disclosure.

### DETAILED DESCRIPTION

As stated in the Background section, federated learning (also known as collaborative learning) is a machine learning technique that trains an algorithm across multiple decentralized edge devices or servers holding local data samples without exchanging them. This approach stands in contrast to traditional centralized machine learning techniques where all the local datasets are uploaded to a server as well as in contrast to classical decentralized approaches which often assume that local data samples are identically distributed.

Federated learning enables multiple actors to build a common, robust machine learning model without sharing data thus allowing to address critical issues, such as data privacy, data security, data access rights and access to heterogeneous data. Its applications are spread over a number of industries including defense, telecommunications, Internet of Things (IoT) and pharmaceutics.

Federated learning aims at training a machine learning algorithm, for instance deep neural networks, on multiple local datasets contained in local nodes (or “clients”) without explicitly exchanging data samples. The general principle consists in training local models on local data samples and utilizing parameters (e.g., weights and biases of a deep neural network) from these local models to generate a global model shared by all clients.

Such a global model is generated by an “aggregator” by performing an aggregation scheme on such parameters, such as by simply averaging their parameters. An aggregator is a software program designed to collect data from multiple sources, such as from multiple clients. Such an aggregator may implement various aggregation schemes, such as computing the marginal median, geometric median or trimmed-mean using the parameters (e.g., weights) from the local models. Such an aggregation scheme may then be used to generate a global model. A global model has global explainability which determines to what extent each feature contributes to how the model makes its predictions over all of the data; whereas, a local model has local explainability which determines to what extent each feature contributes to how the model makes its predictions over a local portion of the data.

The characteristics of the global model may then be shared with the clients to integrate the global model into their machine learning local models.

Clients may desire to verify that the aggregator performed the operations it claimed as well as verify that the aggregator did not manipulate the results for its own ends. For example, in recommender systems for online marketplaces, the owners may be incentivized to promote particular products which have higher margins. In another example, social media platforms may skew optimal machine learning solutions in favor of content that generates “clicks.”

Unfortunately, attempts to verify the trustworthiness of the aggregation schemes utilized by the aggregator have had limited success.

The embodiments of the present disclosure provide a means for verifying the trustworthiness of the aggregation schemes utilized by the aggregator by verifying that each parameter (e.g., weight) of the global model came from an individual real client. In one embodiment, each client determines which of the updated parameters (e.g., weights) of the global model generated by the aggregator correspond to the parameters used by the local model trained on the client. Each client then generates a bit mask (referred to as a “weight-check mask”) indicating which of the updated parameters of the global model correspond to parameters used by the local model trained on the client. Upon receiving such a bit mask from each client by the verification system (configured to verify the trustworthiness of the aggregation scheme utilized by the aggregator), the verification system combines the received bit masks using a homomorphic additive encryption scheme into a mask containing a matrix of values. Such a mask is then sent to the clients to be analyzed, such as by determining if the matrix contains values of only the value of one. If the matrix contains values of only the value of one, then the aggregator has been deemed to be honest. Otherwise, the aggregator has been deemed to be dishonest. These and other features will be discussed in further detail below.

In some embodiments of the present disclosure, the present disclosure comprises a computer-implemented method, system and computer program product for verifying the trustworthiness of an aggregation scheme used in federated learning. In one embodiment of the present disclosure, a bit mask (referred to as a “weight-check mask”) is received from each client used for training a machine learning algorithm using the federated learning technique. Such a bit mask contains values of ones and zeros, where a value of one indicates that the updated parameter of the global model corresponds to a parameter used by the local model trained on the client and a value of zero indicates that the updated parameter of the global model does not correspond to a parameter used by the local model trained on the client. These bit masks, which are encrypted, may then be combined using a homomorphic additive encryption scheme into a mask containing a matrix of values in order to verify the trustworthiness of the aggregation scheme used in federated learning. “Homomorphic encryption,” as used herein, refers to a form of encryption that permits computations to be performed on encrypted data without first decrypting it. These resulting computations are left in an encrypted form which, when decrypted, result in an identical output to that produced had the operations been performed on the unencrypted data. “Homomorphic additive encryption,” as used herein, refers to a homomorphic encryption scheme that supports additions so that adding two ciphertexts (encrypted text transformed from plaintext) together produces the same result as encrypting the sum of the two plaintexts (ordinary readable text). The mask generated by the homomorphic additive encryption scheme is then sent to each client to be analyzed for verification of the trustworthiness of the aggregation scheme used in federated learning. Upon decrypting the encrypted mask, the client determines whether the aggregator is deemed to be honest or dishonest based on whether or not the mask contains a matrix of values of only the value of one. If the mask contains a matrix of values of only the value of one, then the aggregator is deemed to be trustworthy. Otherwise, the aggregator is deemed to be untrustworthy since it cannot be verified that each parameter (e.g., weight) of the global model can be traced back to a real client. In this manner, the trustworthiness of the aggregation schemes utilized by the aggregator is verified by verifying that each parameter (e.g., weight) of the global model came from an individual real client.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill the relevant art.

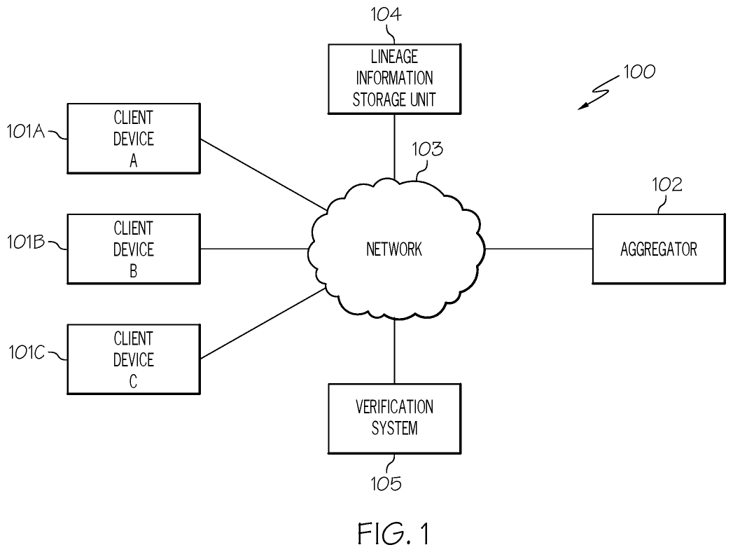

Referring now to the Figures in detail, FIG. 1 illustrates an embodiment of the present disclosure of a communication system 100 for practicing the principles of the present disclosure. Communication system 100 includes client devices (“clients”) 101A-101C (identified as “Client Device A,” “Client Device B,” and “Client Device C,” respectively, in FIG. 1) connected to an aggregator 102 via a network 103. Clients 101A-101C may collectively or individually be referred to as clients 101 or client 101, respectively.

Client 101 may be any type of computing device (e.g., portable computing unit, Personal Digital Assistant (PDA), laptop computer, mobile device, tablet personal computer, smartphone, mobile phone, navigation device, gaming unit, desktop computer system, workstation, Internet appliance and the like) configured with the capability of connecting to network 103 and consequently communicating with other clients 101 and aggregator 102. It is noted that both client 101 and the user of client 101 may be identified with element number 101.

In one embodiment, clients 101 are utilized for a machine learning algorithm (e.g., deep neural networks) using a federated learning technique. Federated learning (also known as collaborative learning) is a machine learning technique that trains an algorithm across multiple clients 101 holding local data samples without exchanging them. As a result, local models are trained using local data samples (“local aggregation”). A “local model,” as used herein, has local explainability which determines to what extent each feature contributes to how the model makes its predictions over a local portion of the data. Parameters, such as weights and gradients, of the local models are then provided to aggregator 102 to generate a global model shared by clients 101. Such parameters may also be referred to herein as “model updates.” A “global model,” as used herein, has global explainability which determines to what extent each feature contributes to how the model makes its predictions over all of the data.

In one embodiment, client 101 implements local aggregation using TensorFlow® Federated. In one embodiment, the local model first constructs tf. Variables to hold aggregates, such as the number of batches or the number of examples processed, the sum of per-batch or per-example losses, etc. In one embodiment, TensorFlow® Federated invokes the forward pass method on the local model multiple times, sequentially over subsequent batches of client data, which allows to update the variables holding various aggregates as a side effect. In one embodiment, TensorFlow® Federated invokes the report_local_unfinalized_metrics method on the local model to allow the local model to compile all the summary statistics it collected into a compact set of metrics to be exported by client 101.

In one embodiment, aggregator 102 is configured to aggregate the model updates of clients 101 using a fusion algorithm to generate the global model. In one embodiment, aggregator 102 coordinates the entire federated learning job. In one embodiment, clients 101 agree on the model architecture (e.g., ResNet®, EfficientNet, etc.), the optimizer to use (e.g., SGD, Adam, AdaGrad, etc.) and the hyperparameters to be used for the federated learning job (e.g., batch size, learning rate, aggregation frequency, etc.). In one embodiment, aggregator 102 is responsible for durably storing the global model and keeping track of the federated learning job.

In one embodiment, aggregator 102 implements an aggregation scheme to aggregate the model updates, which is used to generate the global model. For example, aggregator 102 aggregates the uploaded model parameters using an evenly weighted aggregation, assuming that each client 101 contributes to advancing the global model equally. In one embodiment, aggregator 102 aggregates the uploaded model parameters (model updates) by averaging such uploaded model parameters, which correspond to the new weight parameters (model updates) of the global model. Such a global model, including the new weight parameters, are passed back to client 101. In one embodiment, the global model is passed back to clients 101 via a lineage information storage unit 104 (e.g., distributed ledger, database, etc.) connected to network 103.

In one embodiment, aggregator 102 provides the ability to track data lineage and can trace back to the underlying atomic data that was aggregated. Data lineage is the process of understanding and recording data as it flows from clients 101 to aggregator 102 and back to clients 101. This includes all the transformations the data underwent along the way-how the data was transformed, what changed and why. In one embodiment, aggregator 102 includes data lineage information in the global model passed back to client 101, which is stored in lineage information storage unit 104.

In one embodiment, aggregator 102 implements various data lineage tools for tracking the data lineage of the process in receiving and updating the model updates received from clients 101. Examples of such data lineage tools include, but not limited to, Keboola®, Octopai, Atlan®, Alation®, Collibra®, Dremio®, Kylo, etc.

In one embodiment, aggregator 102 implements a robust aggregation scheme (e.g., median, Krum, etc.) based on a single weight selection implementing the IBM® federated learning framework. For example, the Krum algorithm is a robust aggregation rule which can tolerate f byzantine attackers out of n participants selected at any training round. Krum has theoretical guarantees for the convergence should the condition n≥2f+3 hold true. At any training round, for each model update δᵢ, Krum takes the following steps: (a) computes the pairwise Euclidean distance of n−f−2 updates that are closest to δᵢ, and (b) computes the sum of squared distances between update δᵢ and its closest n−f−2 updates. Then, Krum chooses the model update with the lowest sum to update the parameters of the joint global model.

In one embodiment, the federated learning technique is an iterative learning process. For example, once clients 101 receive the new weight parameters from aggregator 102, such clients 101 may then continue to train the local models using these new weight parameters, which produce a set of model updates, which are then sent to aggregator 102. Such an iterative process continues for a user-designated number of iterations or when the model accuracy is greater than a threshold. Once the iterative process is completed, the global model is said to be finalized.

In one embodiment, aggregator 102 implements federated aggregation, which applies to both the model parameters (variables), which may be averaged across clients 101, as well as the metrics the local models exported as a result of local aggregation. In one embodiment, such federated aggregation is performed using TensorFlow® Federated. In one embodiment, aggregator 102 distributes an initial model, and any parameters required for training, to clients 101 who will participate in a round of training or evaluation. On each client 101, independently and in parallel, the model code is invoked repeatedly on a stream of local data batches to produce a new set of model parameters (when training), and a new set of local metrics, as described above (this is local aggregation). In one embodiment, TensorFlow® Federated runs a distributed aggregation protocol to accumulate and aggregate the model parameters and locally exported metrics across the system. This logic is expressed in a declarative manner using TensorFlow® Federated's federated computation language.

In one embodiment, upon client 101 receiving a global model from aggregator 102, including the finalized global model, client 101 is configured to determine which of the updated parameters (e.g., weights) of the global model correspond to the parameters used by the local model trained on client 101. In one embodiment, client 101 determines which of the updated parameters (e.g., weights) of the global model correspond to the parameters used by the local model trained on client 101 based on the data lineage information provided by aggregator 102. As discussed above, aggregator 102 provides the ability to track data lineage and can trace back to the underlying atomic data that was aggregated. Such data lineage information is included in the global model passed back to clients 101, which is used by clients 101 to determine which of the updated parameters (e.g., weights) of the global model correspond to the parameters used by the local model trained on client 101. In one embodiment, clients 101 keep track of the original parameters (e.g., weights) of the local model trained on client 101. In one embodiment, clients 101 use various tools for keeping track of such parameters including, but not limited to, Neptune, Comet®, MLflow, TensorBoard®, Polyaxon, Valohai, etc.

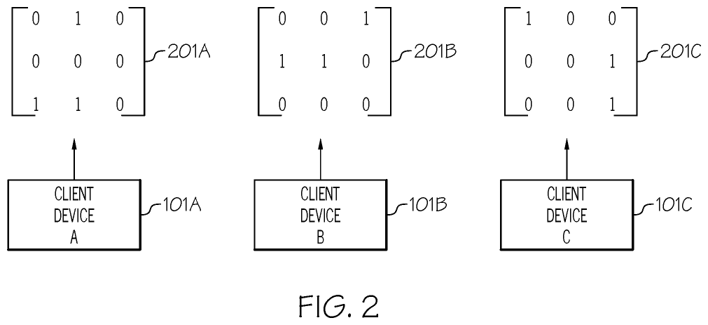

In one embodiment, clients 101 generate a bit mask (referred to as “weight-check mask”) indicating which of the updated parameters of the global model correspond to the parameters used by the local model trained on client 101. Masking, as used herein, refers to keeping, changing or removing a desired part of information. A “bit mask,” as used herein, refers to placing a value of one in the position of an updated parameter of the global model which corresponds to a parameter (e.g., weight) used by the local model trained on client 101 and placing a value of zero in the position of an updated parameter of the global model which corresponds to a parameter (e.g., weight) not used by the local model trained on client 101. In one embodiment, the updated parameters of the global model are in the format of a matrix of values. In one embodiment, the bit mask generated by client 101 is in the format of a matrix of values, such as the values of ones and zeros as illustrated in FIG. 2.

Referring to FIG. 2, FIG. 2 illustrates an example of the bit masks generated by clients 101A-101C to indicate which of the updated parameters (e.g., weights) of the global model correspond to the parameters (e.g., weights) used by the local model trained on client 101 in accordance with an embodiment of the present disclosure.

As shown in FIG. 2, clients 101A-101C generate bit masks 201A-201C, respectively. Bit masks 201A-201C may collectively or individually be referred as bit masks 201 or bit mask 201, respectively. In one embodiment, each bit mask 201 contains values of ones and zeros, where a value of one indicates that the updated parameter of the global model corresponds to a parameter used by the local model trained on client 101 and a value of zero indicates that the updated parameter of the global model does not correspond to a parameter used by the local model trained on client 101.

In one embodiment, such bit masks 201 are encrypted by clients 101 using a secret key. In one embodiment, such bit masks 201 are encrypted using a pseudorandom number generator (PRNG) seed, such as provided by a trusted third party (TTP), where the mask provided by verification system 105 (discussed further below) is decrypted to plaintext using the sum. In one embodiment, such bit masks 201 are encrypted using secure multiparty computation techniques, such as VerifyNet.

In one embodiment, such encrypted bit masks 201 are sent to a verification system 105 connected to network 103 to verify the trustworthiness of the aggregation scheme used by aggregator 102 based on such bit masks 201 as discussed further below.

Referring again to FIG. 1, network 103 may be, for example, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present disclosure.

Furthermore, as discussed above, verification system 105 is connected to network 103. In one embodiment, verification system 105 is configured to verify the trustworthiness of the aggregation scheme used by aggregator 102 based on the encrypted bit masks 201. In one embodiment, verification system 105 performs such verification by combining bit masks 201 received by clients 101 using a homomorphic encryption scheme, such as a homomorphic additive encryption scheme, into a mask containing a matrix of values.

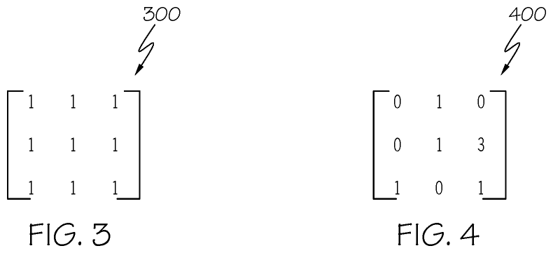

Such a mask (encrypted mask) may then be sent to each client 101 to be analyzed for verification of the trustworthiness of the aggregation scheme used by aggregator 102 based on the values contained in the mask. In one embodiment, client 101 decrypts the encrypted mask using a decryption algorithm with the secret key (used by client 101 for encrypting bit mask 201). In another embodiment, client 101 decrypts the encrypted mask using the sum from the PRNG seed. Upon decrypting the encrypted mask, client 101 determines whether aggregator 102 is deemed to be honest or dishonest based on whether or not the mask contains a matrix of values of only the value of one. If the mask contains a matrix of values of only the value of one, such as shown in FIG. 3, then aggregator 102 is deemed to be trustworthy.

Referring to FIG. 3, FIG. 3 illustrates an example of a mask generated by verification system 105 containing a matrix 300 of values of only the value of one in accordance with an embodiment of the present disclosure. When a mask contains a matrix of values of only the value of one, then such a mask indicates that each parameter (e.g., weight) of the global model can be traced back to client 101. In other words, such a mask verifies that the parameters (e.g., weights) used by aggregator 102 came from clients 101 in a robust manner.

If, however, the mask does not contain a matrix of values of only the value of one, such as shown in FIG. 4, then aggregator 102 is deemed to be untrustworthy since it cannot be verified that each parameter (e.g., weight) of the global model can be traced back to client 101.

Referring to FIG. 4, FIG. 4 illustrates an example of a mask generated by verification system 105 containing a matrix 400 of values that includes one or more values besides the value of one in accordance with an embodiment of the present disclosure. As shown in FIG. 4, there are values other than the value of one in matrix 400, which indicates unclaimed parameters (e.g., weights). Such unclaimed parameters (e.g., weights) can be indicative of aggregator tampering thereby deeming aggregator 102 to be untrustworthy.

Returning to FIG. 1, in one embodiment, verification system 105 is configured to check the distribution of the claimed parameters (e.g., weights) for outliers. That is, verification system 105 is configured to check the distribution of the claimed parameters (e.g., weights) to determine if aggregator 102 favored one or more clients 101.

In one embodiment, verification system 105 receives a client's percentage of its contribution to the parameters (e.g., weights) of the global model from each client 101. For example, client 101A may determine its percentage of contribution of the parameters (e.g., weights) of the global model based on bitmask 201A of FIG. 2, which indicates that 3 of the 9 parameters (e.g., weights) were contributed or used by a local model trained on client 101A. As a result, the percentage of contribution by client 101 A would be 33% ( 3/9). Similarly, client 101B may determine its percentage of contribution of the parameters (weights) of the global model based on bitmask 201B of FIG. 2, which indicates that 3 of the 9 parameters (e.g., weights) were contributed or used by a local model trained on client 101B. As a result, the percentage of contribution by client 101B would be 33% ( 3/9). Furthermore, client 101C may determine its percentage of contribution of the parameters (weights) of the global model based on bitmask 201C of FIG. 2, which indicates that 3 of the 9 parameters (e.g., weights) were contributed or used by a local model trained on client 101C. As a result, the percentage of contribution by client 101C would be 33% ( 3/9). In such an example, verification system 105 would conclude that there are no outliers. That is, verification system 105 would conclude that aggregator 102 did not favor any client 101.

If, however, the percentages received from clients 101 are skewed towards having one or more clients 101 with a much greater percentage of contribution than other clients 101, then verification system 105 may conclude that there are outliers. That is, verification system 105 may conclude that aggregator 102 favored one or more clients 101.

A discussion regarding these and other features will be discussed further below.

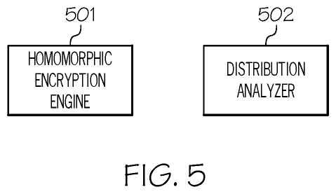

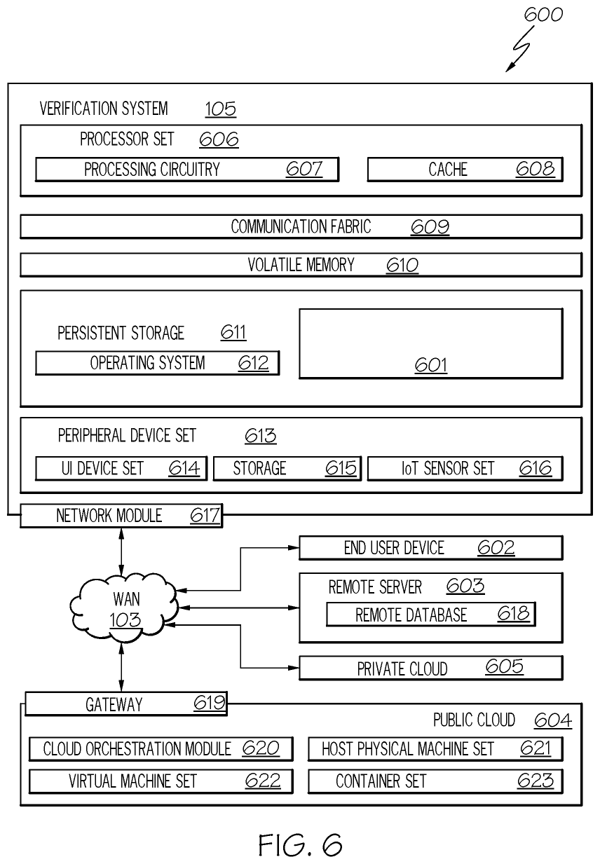

A description of the software components of verification system 105 used for verifying the trustworthiness of the aggregation scheme used by aggregator 102 is provided below in connection with FIG. 5. A description of the hardware configuration of verification system 105 is provided further below in connection with FIG. 6.

System 100 is not to be limited in scope to any one particular network architecture. System 100 may include any number of clients 101, aggregators 102, networks 103, lineage information storage units 104 and verification systems 105.

A discussion regarding the software components used by verification system 105 to verify the trustworthiness of the aggregation scheme used by aggregator 102 is provided below in connection with FIG. 5.

FIG. 5 is a diagram of the software components used by verification system 105 to verify the trustworthiness of the aggregation scheme used by aggregator 102 in accordance with an embodiment of the present disclosure.

Referring to FIG. 5, in conjunction with FIGS. 1-4, verification system 105 includes a homomorphic encryption engine 501 for combining bit masks 201 in encrypted form received from each client 101 using a homomorphic encryption scheme, such as a homomorphic additive encryption scheme, into a mask containing a matrix of values.

“Homomorphic encryption,” as used herein, refers to a form of encryption that permits homomorphic encryption engine 501 to perform computations on encrypted data, such as the encrypted bit masks 201, without first decrypting it. These resulting computations are left in an encrypted form which, when decrypted, result in an identical output to that produced had the operations been performed on the unencrypted data. “Homomorphic additive encryption,” as used herein, refers to a homomorphic encryption scheme that supports additions so that adding two ciphertexts (encrypted text transformed from plaintext) together produces the same result as encrypting the sum of the two plaintexts (ordinary readable text). In one embodiment, homomorphic encryption engine 501 uses various homomorphic encryption schemes including, but not limited to, the Levieil-Naccache scheme, the Brakerski-Gentry-Vaikuntanathan scheme, the NTRU-based scheme by Lopez-Alt, Tromer, and Vaikuntanathan, the Brakerski/Fan-Vercauteren scheme, the FHEW scheme, etc.

In one embodiment, the mask (encrypted mask) generated by homomorphic encryption engine 501 is sent to each client 101 to be analyzed for verification of the trustworthiness of the aggregation scheme used by aggregator 102 based on the values contained in the mask. In one embodiment, client 101 decrypts the encrypted mask using a decryption algorithm with the secret key (used by client 101 for encrypting bit mask 201). In another embodiment, client 101 decrypts the encrypted mask using the sum from the PRNG seed. Upon decrypting the encrypted mask, client 101 determines whether aggregator 102 is deemed to be honest or dishonest based on whether or not the mask contains a matrix of values of only the value of one. If the mask contains a matrix of values of only the value of one, such as shown in FIG. 3, then aggregator 102 is deemed to be trustworthy.

When a mask contains a matrix of values of only the value of one, then such a mask indicates that each parameter (e.g., weight) of the global model can be traced back to client 101. In other words, such a mask verifies that the parameters (e.g., weights) used by aggregator 102 came from clients 101 in a robust manner.

If, however, the mask does not contain a matrix of values of only the value of one, such as shown in FIG. 4, then aggregator 102 is deemed to be untrustworthy since it cannot be verified that each parameter (e.g., weight) of the global model can be traced back to client 101.

As shown in FIG. 4, there are values other than the value of one in matrix 400, which indicates unclaimed parameters (e.g., weights). Such unclaimed parameters (e.g., weights) can be indicative of aggregator tampering thereby deeming aggregator 102 to be untrustworthy.

Referring again to FIG. 5, verification system 105 further includes a distribution analyzer 502 configured to determine if aggregator 102 is relying on the updated parameters more exclusively from one or more clients 101 when implementing its aggregation scheme.

In one embodiment, distribution analyzer 502 receives a client's percentage of its contribution to the parameters (e.g., weights) of the global model from each client 101. For example, client 101A may determine its percentage of contribution of the parameters (e.g., weights) of the global model based on bitmask 201A of FIG. 2, which indicates that 3 of the 9 parameters (e.g., weights) were contributed or used by a local model trained on client 101A. As a result, the percentage of contribution by client 101 A would be 33% ( 3/9). Similarly, client 101B may determine its percentage of contribution of the parameters (weights) of the global model based on bitmask 201B of FIG. 2, which indicates that 3 of the 9 parameters (e.g., weights) were contributed or used by a local model trained on client 101B. As a result, the percentage of contribution by client 101B would be 33% ( 3/9). Furthermore, client 101C may determine its percentage of contribution of the parameters (weights) of the global model based on bitmask 201C of FIG. 2, which indicates that 3 of the 9 parameters (e.g., weights) were contributed or used by a local model trained on client 101C. As a result, the percentage of contribution by client 101C would be 33% ( 3/9). In such an example, verification system 105 would conclude that there are no outliers. That is, verification system 105 would conclude that aggregator 102 did not favor any client 101.

If, however, the percentages received from clients 101 are skewed towards having one or more clients 101 with a much greater percentage of contribution than other clients 101, then distribution analyzer 502 may conclude that there are outliers. That is, distribution analyzer 502 may conclude that aggregator 102 favored one or more clients 101.

A further description of these and other features is provided below in connection with the discussion of the method for verifying the trustworthiness of the aggregation scheme used in federated learning.

Prior to the discussion of the method for verifying the trustworthiness of the aggregation scheme used in federated learning, a description of the hardware configuration of verification system 105 (FIG. 1) is provided below in connection with FIG. 6.

Referring now to FIG. 6, in conjunction with FIG. 1, FIG. 6 illustrates an embodiment of the present disclosure of the hardware configuration of verification system 105 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 600 contains an example of an environment for the execution of at least some of the computer code (stored in block 601) involved in performing the inventive methods, such as verifying the trustworthiness of the aggregation scheme used in federated learning. In addition to block 601, computing environment 600 includes, for example, verification system 105, network 103, such as a wide area network (WAN), end user device (EUD) 602, remote server 603, public cloud 604, and private cloud 605. In this embodiment, verification system 105 includes processor set 606 (including processing circuitry 607 and cache 608), communication fabric 609, volatile memory 610, persistent storage 611 (including operating system 612 and block 601, as identified above), peripheral device set 613 (including user interface (UI) device set 614, storage 615, and Internet of Things (IoT) sensor set 616), and network module 617. Remote server 603 includes remote database 618. Public cloud 604 includes gateway 619, cloud orchestration module 620, host physical machine set 621, virtual machine set 622, and container set 623.

Verification system 105 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 618. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically verification system 105, to keep the presentation as simple as possible. Verification system 105 may be located in a cloud, even though it is not shown in a cloud in FIG. 6. On the other hand, verification system 105 is not required to be in a cloud except to any extent as may be affirmatively indicated.

Processor set 606 includes one, or more, computer processors of any type now known or to be developed in the future. Processing circuitry 607 may be distributed over multiple packages, for example, multiple, coordinated integrated circuit chips. Processing circuitry 607 may implement multiple processor threads and/or multiple processor cores. Cache 608 is memory that is located in the processor chip package(s) and is typically used for data or code that should be available for rapid access by the threads or cores running on processor set 606. Cache memories are typically organized into multiple levels depending upon relative proximity to the processing circuitry. Alternatively, some, or all, of the cache for the processor set may be located “off chip.” In some computing environments, processor set 606 may be designed for working with qubits and performing quantum computing.

Computer readable program instructions are typically loaded onto verification system 105 to cause a series of operational steps to be performed by processor set 606 of verification system 105 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 608 and the other storage media discussed below. The program instructions, and associated data, are accessed by processor set 606 to control and direct performance of the inventive methods. In computing environment 600, at least some of the instructions for performing the inventive methods may be stored in block 601 in persistent storage 611.

Communication fabric 609 is the signal conduction paths that allow the various components of verification system 105 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 610 is any type of volatile memory now known or to be developed in the future. Examples include dynamic type random access memory (RAM) or static type RAM. Typically, the volatile memory is characterized by random access, but this is not required unless affirmatively indicated. In verification system 105, the volatile memory 610 is located in a single package and is internal to verification system 105, but, alternatively or additionally, the volatile memory may be distributed over multiple packages and/or located externally with respect to verification system 105.

Persistent Storage 611 is any form of non-volatile storage for computers that is now known or to be developed in the future. The non-volatility of this storage means that the stored data is maintained regardless of whether power is being supplied to verification system 105 and/or directly to persistent storage 611. Persistent storage 611 may be a read only memory (ROM), but typically at least a portion of the persistent storage allows writing of data, deletion of data and re-writing of data. Some familiar forms of persistent storage include magnetic disks and solid state storage devices. Operating system 612 may take several forms, such as various known proprietary operating systems or open source Portable Operating System Interface type operating systems that employ a kernel. The code included in block 601 typically includes at least some of the computer code involved in performing the inventive methods.

Peripheral device set 613 includes the set of peripheral devices of verification system 105. Data communication connections between the peripheral devices and the other components of verification system 105 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 614 may include components such as a display screen, speaker, microphone, wearable devices (such as goggles and smart watches), keyboard, mouse, printer, touchpad, game controllers, and haptic devices. Storage 615 is external storage, such as an external hard drive, or insertable storage, such as an SD card. Storage 615 may be persistent and/or volatile. In some embodiments, storage 615 may take the form of a quantum computing storage device for storing data in the form of qubits. In embodiments where verification system 105 is required to have a large amount of storage (for example, where verification system 105 locally stores and manages a large database) then this storage may be provided by peripheral storage devices designed for storing very large amounts of data, such as a storage area network (SAN) that is shared by multiple, geographically distributed computers. IoT sensor set 616 is made up of sensors that can be used in Internet of Things applications. For example, one sensor may be a thermometer and another sensor may be a motion detector.

Network module 617 is the collection of computer software, hardware, and firmware that allows verification system 105 to communicate with other computers through WAN 103. Network module 617 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 617 are performed on the same physical hardware device. In other embodiments (for example, embodiments that utilize software-defined networking (SDN)), the control functions and the forwarding functions of network module 617 are performed on physically separate devices, such that the control functions manage several different network hardware devices. Computer readable program instructions for performing the inventive methods can typically be downloaded to verification system 105 from an external computer or external storage device through a network adapter card or network interface included in network module 617.

WAN 103 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 602 is any computer system that is used and controlled by an end user (for example, a customer of an enterprise that operates verification system 105), and may take any of the forms discussed above in connection with verification system 105. EUD 602 typically receives helpful and useful data from the operations of verification system 105. For example, in a hypothetical case where verification system 105 is designed to provide a recommendation to an end user, this recommendation would typically be communicated from network module 617 of verification system 105 through WAN 103 to EUD 602. In this way, EUD 602 can display, or otherwise present, the recommendation to an end user. In some embodiments, EUD 602 may be a client device, such as thin client, heavy client, mainframe computer, desktop computer and so on.

Remote server 603 is any computer system that serves at least some data and/or functionality to verification system 105. Remote server 603 may be controlled and used by the same entity that operates verification system 105. Remote server 603 represents the machine(s) that collect and store helpful and useful data for use by other computers, such as verification system 105. For example, in a hypothetical case where verification system 105 is designed and programmed to provide a recommendation based on historical data, then this historical data may be provided to verification system 105 from remote database 618 of remote server 603.

Public cloud 604 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 604 is performed by the computer hardware and/or software of cloud orchestration module 620. The computing resources provided by public cloud 604 are typically implemented by virtual computing environments that run on various computers making up the computers of host physical machine set 621, which is the universe of physical computers in and/or available to public cloud 604. The virtual computing environments (VCEs) typically take the form of virtual machines from virtual machine set 622 and/or containers from container set 623. It is understood that these VCEs may be stored as images and may be transferred among and between the various physical machine hosts, either as images or after instantiation of the VCE. Cloud orchestration module 620 manages the transfer and storage of images, deploys new instantiations of VCEs and manages active instantiations of VCE deployments. Gateway 619 is the collection of computer software, hardware, and firmware that allows public cloud 604 to communicate through WAN 103.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 605 is similar to public cloud 604, except that the computing resources are only available for use by a single enterprise. While private cloud 605 is depicted as being in communication with WAN 103 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 604 and private cloud 605 are both part of a larger hybrid cloud.

Block 601 further includes the software components discussed above in connection with FIG. 5 to verify the trustworthiness of the aggregation scheme used in federated learning. In one embodiment, such components may be implemented in hardware. The functions discussed above performed by such components are not generic computer functions. As a result, verification system 105 is a particular machine that is the result of implementing specific, non-generic computer functions.

In one embodiment, the functionality of such software components of verification system 105, including the functionality for verifying the trustworthiness of the aggregation scheme used in federated learning, may be embodied in an application specific integrated circuit.

As stated above, federated learning enables multiple actors to build a common, robust machine learning model without sharing data thus allowing to address critical issues, such as data privacy, data security, data access rights and access to heterogeneous data. Its applications are spread over a number of industries including defense, telecommunications, Internet of Things (IoT) and pharmaceutics. Federated learning aims at training a machine learning algorithm, for instance deep neural networks, on multiple local datasets contained in local nodes (or “clients”) without explicitly exchanging data samples. The general principle consists in training local models on local data samples and utilizing parameters (e.g., weights and biases of a deep neural network) from these local models to generate a global model shared by all clients. Such a global model is generated by an “aggregator” by performing an aggregation scheme on such parameters, such as by simply averaging their parameters. An aggregator is a software program designed to collect data from multiple sources, such as from multiple clients. Such an aggregator may implement various aggregation schemes, such as computing the marginal median, geometric median or trimmed-mean using the parameters (e.g., weights) from the local models. Such an aggregation scheme may then be used to generate a global model. A global model has global explainability which determines to what extent each feature contributes to how the model makes its predictions over all of the data; whereas, a local model has local explainability which determines to what extent each feature contributes to how the model makes its predictions over a local portion of the data. The characteristics of the global model may then be shared with the clients to integrate the global model into their machine learning local models. Clients may desire to verify that the aggregator performed the operations it claimed as well as verify that the aggregator did not manipulate the results for its own ends. For example, in recommender systems for online marketplaces, the owners may be incentivized to promote particular products which have higher margins. In another example, social media platforms may skew optimal machine learning solutions in favor of content that generates “clicks.” Unfortunately, attempts to verify the trustworthiness of the aggregation schemes utilized by the aggregator have had limited success.

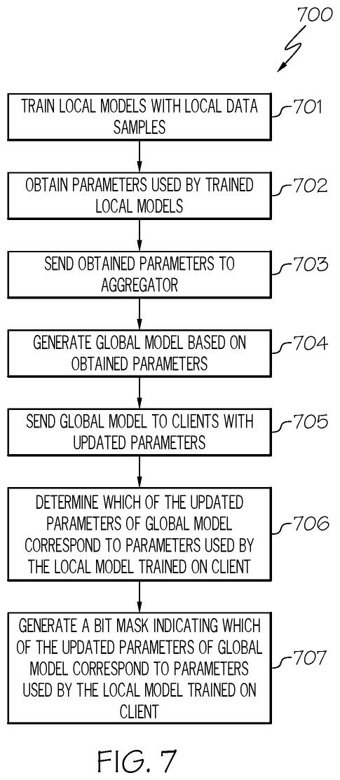

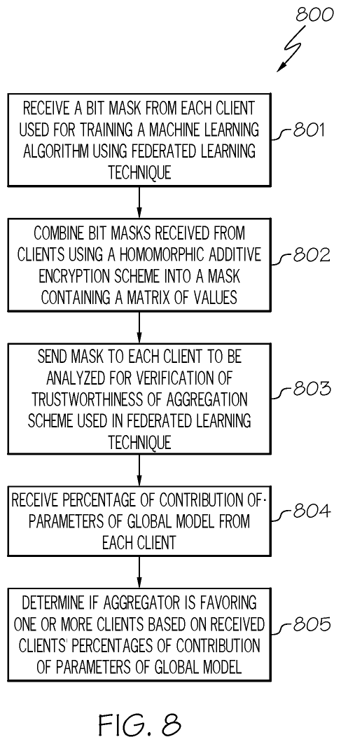

The embodiments of the present disclosure provide a means for verifying the trustworthiness of the aggregation schemes utilized by the aggregator by verifying that each parameter (e.g., weight) of the global model came from an individual real client as discussed below in connection with FIGS. 7 and 8. FIG. 7 is a flowchart of a method for identifying which updated parameters (e.g., weights) of the global model correspond to the parameters used by the local models trained on clients 101. FIG. 8 is a flowchart of a method for verifying the trustworthiness of the aggregation scheme used in the federated learning technique.

As stated above, FIG. 7 is a flowchart of a method 700 for identifying which updated parameters (e.g., weights) of the global model correspond to the parameters used by the local models trained on clients 101 in accordance with an embodiment of the present disclosure.

Referring to FIG. 7, in conjunction with FIGS. 1-6, in step 701, clients 101 train local models with local data samples.

As discussed above, in one embodiment, clients 101 are utilized for training a machine learning algorithm (e.g., deep neural networks) using a federated learning technique. Federated learning (also known as collaborative learning) is a machine learning technique that trains an algorithm across multiple clients 101 holding local data samples without exchanging them. As a result, local models are trained using local data samples (“local aggregation”). A “local model,” as used herein, has local explainability which determines to what extent each feature contributes to how the model makes its predictions over a local portion of the data.

In one embodiment, client 101 implements local aggregation using TensorFlow® Federated. In one embodiment, the local model first constructs tf. Variables to hold aggregates, such as the number of batches or the number of examples processed, the sum of per-batch or per-example losses, etc. In one embodiment, TensorFlow® Federated invokes the forward_pass method on the local model multiple times, sequentially over subsequent batches of client data, which allows to update the variables holding various aggregates as a side effect. In one embodiment, TensorFlow® Federated invokes the report_local_unfinalized_metrics method on the local model to allow the local model to compile all the summary statistics it collected into a compact set of metrics to be exported by client 101.

In step 702, clients 101 obtain the parameters (e.g., weights) used by the trained local models.

In step 703, clients 101 send the obtained parameters (e.g., weights) to aggregator 102.

In step 704, aggregator 102 generates a global model based on such obtained parameters.

As discussed above, parameters, such as weights and gradients, of the local models are obtained by clients 101 and then provided to aggregator 102 to generate a global model shared by clients 101. Such parameters may also be referred to herein as “model updates.” A “global model,” as used herein, has global explainability which determines to what extent each feature contributes to how the model makes its predictions over all of the data.

In one embodiment, aggregator 102 is configured to aggregate the model updates of clients 101 using a fusion algorithm to generate the global model. In one embodiment, aggregator 102 coordinates the entire federated learning job. In one embodiment, clients 101 agree on the model architecture (e.g., ResNet®, EfficientNet, etc.), the optimizer to use (e.g., SGD, Adam, AdaGrad, etc.) and the hyperparameters to be used for the federated learning job (e.g., batch size, learning rate, aggregation frequency etc.). In one embodiment, aggregator 102 is responsible for durably storing the global model and keeping track of the federated learning job.

In one embodiment, aggregator 102 implements an aggregation scheme to aggregate the model updates, which is used to generate the global model. For example, aggregator 102 aggregates the uploaded model parameters using an evenly weighted aggregation, assuming that each client 101 contributes to advancing the global model equally. In one embodiment, aggregator 102 aggregates the uploaded model parameters (model updates) by averaging such uploaded model parameters, which correspond to the new weight parameters (model updates) of the global model. Such a global model, including the new weight parameters, are passed back to client 101. In one embodiment, the global model is passed back to clients 101 via a lineage information storage unit 104 (e.g., distributed ledger, database, etc.) connected to network 103.

In one embodiment, aggregator 102 provides the ability to track data lineage and can trace back to the underlying atomic data that was aggregated. Data lineage is the process of understanding and recording data as it flows from clients 101 to aggregator 102 and back to clients 101. This includes all the transformations the data underwent along the way-how the data was transformed, what changed and why. In one embodiment, aggregator 102 includes data lineage information in the global model passed back to client 101, which is stored in lineage information storage unit 104.

In one embodiment, aggregator 102 implements various data lineage tools for tracking the data lineage of the process in receiving and updating the model updates received from clients 101. Examples of such data lineage tools include, but not limited to, Keboola®, Octopai, Atlan®, Alation®, Collibra®, Dremio®, Kylo, etc.

In one embodiment, aggregator 102 implements a robust aggregation scheme (e.g., median, Krum, etc.) based on a single weight selection implementing the IBM® federated learning framework. For example, the Krum algorithm is a robust aggregation rule which can tolerate f byzantine attackers out of n participants selected at any training round. Krum has theoretical guarantees for the convergence should the condition n≥2f+3 hold true. At any training round, for each model update δᵢ, Krum takes the following steps: (a) computes the pairwise Euclidean distance of n−f−2 updates that are closest to δᵢ, and (b) computes the sum of squared distances between update δᵢ and its closest n−f−2 updates. Then, Krum chooses the model update with the lowest sum to update the parameters of the joint global model.

In one embodiment, the federated learning technique is an iterative learning process. For example, once clients 101 receive the new weight parameters from aggregator 102, such clients 101 may then continue to train the local models using these new weight parameters, which produce a set of model updates, which are then sent to aggregator 102. Such an iterative process continues for a user-designated number of iterations or when the model accuracy is greater than a threshold. Once the iterative process is completed, the global model is said to be finalized.

In one embodiment, aggregator 102 implements federated aggregation, which applies to both the model parameters (variables), which may be averaged across clients 101, as well as the metrics the local models exported as a result of local aggregation. In one embodiment, such federated aggregation is performed using TensorFlow® Federated. In one embodiment, aggregator 102 distributes an initial model, and any parameters required for training, to clients 101 who will participate in a round of training or evaluation. On each client 101, independently and in parallel, the model code is invoked repeatedly on a stream of local data batches to produce a new set of model parameters (when training), and a new set of local metrics, as described above (this is local aggregation). In one embodiment, TensorFlow® Federated runs a distributed aggregation protocol to accumulate and aggregate the model parameters and locally exported metrics across the system. This logic is expressed in a declarative manner using TensorFlow® Federated's federated computation language.

In step 705, aggregator 102 sends the generated global model with the updated parameters, including the data lineage information, to clients 101. In one embodiment, the global model, including the data lineage information, is stored in lineage information storage unit 104 prior to being sent to clients 101.

In step 706, clients 101 determine which of the updated parameters of the global model correspond to the parameters used by the local model trained on client 101.

As discussed above, in one embodiment, upon client 101 receiving a global model from aggregator 102, including the finalized global model, client 101 is configured to determine which of the updated parameters (e.g., weights) of the global model correspond to the parameters used by the local model trained on client 101. In one embodiment, client 101 determines which of the updated parameters (e.g., weights) of the global model correspond to the parameters used by the local model trained on client 101 based on the data lineage information provided by aggregator 102. As discussed above, aggregator 102 provides the ability to track data lineage and can trace back to the underlying atomic data that was aggregated. Such data lineage information is included in the global model passed back to clients 101, which is used by clients 101 to determine which of the updated parameters (e.g., weights) of the global model correspond to the parameters used by the local model trained on client 101. In one embodiment, clients 101 keep track of the original parameters (e.g., weights) of the local model trained on client 101. In one embodiment, clients 101 use various tools for keeping track of such parameters including, but not limited to, Neptune, Comet®, MLflow, TensorBoard®, Polyaxon, Valohai, etc.

In step 707, clients 101 generate a bit mask (referred to as “weight-check mask”) indicating which of the updated parameters of the global model correspond to the parameters used by the local model trained on client 101.

As stated above, masking, as used herein, refers to keeping, changing or removing a desired part of information. A “bit mask,” as used herein, refers to placing a value of one in the position of an updated parameter of the global model which corresponds to a parameter (e.g., weight) used by the local model trained on client 101 and placing a value of zero in the position of an updated parameter of the global model which corresponds to a parameter (e.g., weight) not used by the local model trained on client 101. As discussed above, in one embodiment, the updated parameters of the global model are in the format of a matrix of values. In one embodiment, the bit mask generated by client 101 is in the format of a matrix of values, such as the values of ones and zeros as illustrated in FIG. 2.

As shown in FIG. 2, clients 101A-101C generate bit masks 201A-201C, respectively. In one embodiment, each bit mask 201 contains values of ones and zeros, where a value of one indicates that the updated parameter of the global model corresponds to a parameter used by the local model trained on client 101 and a value of zero indicates that the updated parameter of the global model does not correspond to a parameter used by the local model trained on client 101.

In one embodiment, such bit masks 201 are encrypted by clients 101 using a secret key. In one embodiment, such bit masks 201 are encrypted using a pseudorandom number generator (PRNG) seed, such as provided by a trusted third party (TTP), where the mask provided by verification system 105, as discussed below, is decrypted to plaintext using the sum. In one embodiment, such bit masks 201 are encrypted using secure multiparty computation techniques, such as Verify Net.

In one embodiment, such encrypted bit masks 201 are sent to verification system 105 to verify the trustworthiness of the aggregation scheme used by aggregator 102 based on such bit masks 201 as discussed below in connection with FIG. 8.

FIG. 8 is a flowchart of a method 800 for verifying the trustworthiness of the aggregation scheme used in the federated learning technique in accordance with an embodiment of the present disclosure.

Referring to FIG. 8, in conjunction with FIGS. 1-7, in step 801, homomorphic encryption engine 501 of verification system 105 receives bit mask 201 from each client 101 used for training a machine learning algorithm using the federated learning technique.

As discussed above, in one embodiment, such bit masks 201 are encrypted by clients 101. In one embodiment, such encrypted bit masks 201 are sent to verification system 105 connected to network 103 to verify the trustworthiness of the aggregation scheme used by aggregator 102 based on such bit masks 201.

In step 802, homomorphic encryption engine 501 of verification system 105 combines bit masks 201 in encrypted form that were received from each client 101 using a homomorphic encryption scheme, such as the homomorphic additive encryption scheme, into a mask containing a matrix of values in order to verify the trustworthiness of the aggregation scheme used in federated learning.

As stated above, “homomorphic encryption,” as used herein, refers to a form of encryption that permits homomorphic encryption engine 501 to perform computations on encrypted data, such as the encrypted bit masks 201, without first decrypting it. These resulting computations are left in an encrypted form which, when decrypted, result in an identical output to that produced had the operations been performed on the unencrypted data. “Homomorphic additive encryption,” as used herein, refers to a homomorphic encryption scheme that supports additions so that adding two ciphertexts (encrypted text transformed from plaintext) together produces the same result as encrypting the sum of the two plaintexts (ordinary readable text). In one embodiment, homomorphic encryption engine 501 uses various homomorphic encryption schemes including, but not limited to, the Levieil-Naccache scheme, the Brakerski-Gentry-Vaikuntanathan scheme, the NTRU-based scheme by Lopez-Alt, Tromer, and Vaikuntanathan, the Brakerski/Fan-Vercauteren scheme, the FHEW scheme, etc.

In step 803, homomorphic encryption engine 501 of verification system 105 sends the mask to each client 101 to be analyzed for verification of the trustworthiness of the aggregation scheme used in the federated learning technique.

As discussed above, the mask (encrypted mask) generated by homomorphic encryption engine 501 may be sent to each client 101 to be analyzed for verification of the trustworthiness of the aggregation scheme used by aggregator 102 based on the values contained in the mask. In one embodiment, client 101 decrypts the encrypted mask using a decryption algorithm with the secret key (used by client 101 for encrypting bit mask 201). In another embodiment, client 101 decrypts the encrypted mask using the sum from the PRNG seed. Upon decrypting the encrypted mask, client 101 determines whether aggregator 102 is deemed to be honest or dishonest based on whether or not the mask contains a matrix of values of only the value of one. If the mask contains a matrix of values of only the value of one, such as shown in FIG. 3, then aggregator 102 is deemed to be trustworthy.

When a mask contains a matrix of values of only the value of one, then such a mask indicates that each parameter (e.g., weight) of the global model can be traced back to client 101. In other words, such a mask verifies that the parameters (e.g., weights) used by aggregator 102 came from clients 101 in a robust manner. Such a verification is performed while maintaining privacy of the client's contributions.

If, however, the mask does not contain a matrix of values of only the value of one, such as shown in FIG. 4, then aggregator 102 is deemed to be untrustworthy since it cannot be verified that each parameter (e.g., weight) of the global model can be traced back to client 101.

As shown in FIG. 4, there are values other than the value of one in matrix 400, which indicates unclaimed parameters (e.g., weights). Such unclaimed parameters (e.g., weights) can be indicative of aggregator tampering thereby deeming aggregator 102 to be untrustworthy.

In step 804, distribution analyzer 502 of verification system 105 receives a client's percentage of its contribution to the parameters (e.g., weights) of the global model from each client 101.

In step 805, distribution analyzer 502 of verification system 105 determines if aggregator 102 is favoring one or more clients 101 based on the clients' percentages of contribution to the parameters (e.g., weights) of the global model.

As previously discussed, such information (clients' percentages of contribution to the parameters (e.g., weights) of the global model) may be used by distribution analyzer 502 to determine if aggregator 102 is relying on the model updates more exclusively from one or more clients 101 than other clients 101 when implementing its aggregation scheme.

For example, client 101A may determine its percentage of contribution of the parameters (e.g., weights) of the global model based on bitmask 201A of FIG. 2, which indicates that 3 of the 9 parameters (e.g., weights) were contributed or used by a local model trained on client 101A. As a result, the percentage of contribution by client 101 A would be 33% ( 3/9). Similarly, client 101B may determine its percentage of contribution of the parameters (weights) of the global model based on bitmask 201B of FIG. 2, which indicates that 3 of the 9 parameters (e.g., weights) were contributed or used by a local model trained on client 101B. As a result, the percentage of contribution by client 101B would be 33% ( 3/9). Furthermore, client 101C may determine its percentage of contribution of the parameters (weights) of the global model based on bitmask 201C of FIG. 2, which indicates that 3 of the 9 parameters (e.g., weights) were contributed or used by a local model trained on client 101C. As a result, the percentage of contribution by client 101C would be 33% ( 3/9). In such an example, distribution analyzer 502 would conclude that there are no outliers. That is, distribution analyzer 502 would conclude that aggregator 102 did not favor any client 101.

If, however, the percentages received from clients 101 are skewed towards having one or more clients 101 with a much greater percentage of contribution than other clients 101, then distribution analyzer 502 may conclude that there are outliers. That is, distribution analyzer 502 may conclude that aggregator 102 favored one or more clients 101.

In one embodiment, the principles of the present disclosure also support verification when some of clients 101 are being untruthful and attempt to evade the protocol of the present disclosure.

That is, such clients 101 may attempt to deceive the protocol of the present disclosure. Embodiments for addressing such deception are discussed below.

For example, the values of bit masks 201 sent to verification system 105 by client 101 may include falsified values of ones and zeros. For instance, clients 101 may include the value of 0 (as opposed to the value of 1) in bit mask 201 to indicate that the updated parameter of the global model did not correspond to a parameter used by the local model trained on client 101 when such a case did occur. That is, client 101 should include the value of 1 as opposed to the value of 0 when the updated parameter of the global model corresponds to the parameter used by the local model trained on client 101. In such situations, the following scheme may be utilized to detect such falsification.

In one embodiment, in such situations, verification system 105 requests clients 101 to publish the commitments (values of bit mask 201 indicating whether the updated parameter of the global model corresponds to a parameter used by the local model trained on client 101) of every parameter they sent to aggregator 102. That is, verification system 105 requests clients 101 to publish bit masks 201. Furthermore, in one embodiment, verification system 105 requests a trusted third party to publish the commitments provided to aggregator 102 by clients 101. In one embodiment, a trusted third party may coordinate with aggregator 102 and/or clients 101 to also receive the commitments provided to aggregator 102 by clients 101. A “trusted third party,” as used herein, is an entity which facilitates interactions between two parties (e.g., clients 101, aggregator 102) who both trust the third party. In one embodiment, upon receiving the commitments from clients 101 and the trusted third party, verification system 105 compares such commitments. If there is a difference between such commitments, then such a client 101 is deemed to be “malicious.” That is, such a client 101 is deemed to be untruthful and attempting to evade the protocol of the present disclosure

Another example of falsification by client 101 is if client 101 includes the value of 1 in bit mask 201 to indicate that the updated parameter of the global model corresponds to a parameter used by the local model trained on client 101 when such a case did not occur. That is, client 101 should include the value of 0 as opposed to the value of 1 when the updated parameter of the global model did not correspond to the parameter used by the local model trained on client 101. In such situations, the following scheme may be utilized to detect such falsification.

In one embodiment, in such situations, verification system 105 compares the bit masks 201 from clients 101 pair wise and flags which bit masks 201 provide an error. Malicious clients will supply bit masks 201 that overlap randomly with bit masks 201 provided by truthful clients. As a result, by comparing bit masks 201 from clients 101 pair wise, such deception by the malicious client may be detected.

Furthermore, in one embodiment, such pair wise comparisons of bit masks 201 may be performed in multiple rounds to detect the malicious client being untruthful with respect to a single commitment. With a high probability that a malicious client's bit mask 201 will overlap bit masks 201 provided by truthful clients in different rounds, the deception performed by the malicious client, including being untruthful with respect to a single commitment, may be detected.

In this manner, the principles of the present disclosure verify the trustworthiness of the aggregation schemes utilized by the aggregator in a federated learning technique by verifying that each parameter (e.g., weight) of the global model generated by the aggregator came from an individual real client. Furthermore, the principles of the present disclosure determine whether the aggregator is favoring one or more clients based on the clients' percentages of contribution to the parameters (e.g., weights) of the global model.

Furthermore, the principles of the present disclosure improve the technology or technical field involving federated learning. As discussed above, federated learning enables multiple actors to build a common, robust machine learning model without sharing data thus allowing to address critical issues, such as data privacy, data security, data access rights and access to heterogeneous data. Its applications are spread over a number of industries including defense, telecommunications, Internet of Things (IoT) and pharmaceutics. Federated learning aims at training a machine learning algorithm, for instance deep neural networks, on multiple local datasets contained in local nodes (or “clients”) without explicitly exchanging data samples. The general principle consists in training local models on local data samples and utilizing parameters (e.g., weights and biases of a deep neural network) from these local models to generate a global model shared by all clients. Such a global model is generated by an “aggregator” by performing an aggregation scheme on such parameters, such as by simply averaging their parameters. An aggregator is a software program designed to collect data from multiple sources, such as from multiple clients. Such an aggregator may implement various aggregation schemes, such as computing the marginal median, geometric median or trimmed-mean using the parameters (e.g., weights) from the local models. Such an aggregation scheme may then be used to generate a global model. A global model has global explainability which determines to what extent each feature contributes to how the model makes its predictions over all of the data; whereas, a local model has local explainability which determines to what extent each feature contributes to how the model makes its predictions over a local portion of the data. The characteristics of the global model may then be shared with the clients to integrate the global model into their machine learning local models. Clients may desire to verify that the aggregator performed the operations it claimed as well as verify that the aggregator did not manipulate the results for its own ends. For example, in recommender systems for online marketplaces, the owners may be incentivized to promote particular products which have higher margins. In another example, social media platforms may skew optimal machine learning solutions in favor of content that generates “clicks.” Unfortunately, attempts to verify the trustworthiness of the aggregation schemes utilized by the aggregator have had limited success.

Embodiments of the present disclosure improve such technology by receiving a bit mask (referred to as a “weight-check mask”) from each client used for training a machine learning algorithm using the federated learning technique. Such a bit mask contains values of ones and zeros, where a value of one indicates that the updated parameter of the global model corresponds to a parameter used by the local model trained on the client and a value of zero indicates that the updated parameter of the global model does not correspond to a parameter used by the local model trained on the client. These bit masks, which are encrypted, may then be combined using a homomorphic additive encryption scheme into a mask containing a matrix of values in order to verify the trustworthiness of the aggregation scheme used in federated learning. “Homomorphic encryption,” as used herein, refers to a form of encryption that permits computations to be performed on encrypted data without first decrypting it. These resulting computations are left in an encrypted form which, when decrypted, result in an identical output to that produced had the operations been performed on the unencrypted data. “Homomorphic additive encryption,” as used herein, refers to a homomorphic encryption scheme that supports additions so that adding two ciphertexts (encrypted text transformed from plaintext) together produces the same result as encrypting the sum of the two plaintexts (ordinary readable text). The mask generated by the homomorphic additive encryption scheme is then sent to each client to be analyzed for verification of the trustworthiness of the aggregation scheme used in federated learning. Upon decrypting the encrypted mask, the client determines whether the aggregator is deemed to be honest or dishonest based on whether or not the mask contains a matrix of values of only the value of one. If the mask contains a matrix of values of only the value of one, then the aggregator is deemed to be trustworthy. Otherwise, the aggregator is deemed to be untrustworthy since it cannot be verified that each parameter (e.g., weight) of the global model can be traced back to a real client. In this manner, the trustworthiness of the aggregation schemes utilized by the aggregator is verified by verifying that each parameter (e.g., weight) of the global model came from an individual real client. Furthermore, in this manner, there is an improvement in the technical field involving federated learning.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for verifying trustworthiness of an aggregation scheme used in federated learning, the method comprising:
receiving a bit mask from each of a plurality of clients used for training a machine learning algorithm using said federated learning, wherein said bit mask indicates which parameters of a global model computed by an aggregator using said federated learning correspond to parameters used by a local model trained on a client;
combining said bit masks received from said plurality of clients using a homomorphic additive encryption scheme into a mask containing a matrix of values; and
sending said mask to each of said plurality of clients to be analyzed by each of said plurality of clients, wherein said verification of said trustworthiness of said aggregation scheme used in said federated learning by said aggregator is determined based on said matrix of values.

2. The method as recited in claim 1, wherein said aggregator is deemed to be dishonest in response to said matrix not containing values of only a value of one.

3. The method as recited in claim 1, wherein said aggregator is deemed to be honest in response to said matrix containing values of only a value of one.

4. The method as recited in claim 1 further comprising:
receiving a client's percentage of contribution of said parameters of said global model from each of said plurality of clients.

5. The method as recited in claim 4 further comprising:
determining if said aggregator is favoring one or more clients of said plurality of clients based on said received client's percentage of contribution of said parameters of said global model from each of said plurality of clients.

6. The method as recited in claim 1, wherein said mask containing said matrix of values that is received by each of said plurality of clients is encrypted, wherein said mask is decrypted by each of said plurality of clients using a secret key.

7. The method as recited in claim 1, wherein a first client of said plurality of clients includes falsification of one or more values in a first bit mask, wherein said falsification is detected by comparing commitments in said first bit mask with commitments provided to a trusted third party by said first client or by comparing said first bit mask with other bit masks provided by other clients pair wise.

8. A computer program product for verifying trustworthiness of an aggregation scheme used in federated learning, the computer program product comprising one or more computer readable storage mediums having program code embodied therewith, the program code comprising programming instructions for:
receiving a bit mask from each of a plurality of clients used for training a machine learning algorithm using said federated learning, wherein said bit mask indicates which parameters of a global model computed by an aggregator using said federated learning correspond to parameters used by a local model trained on a client;
combining said bit masks received from said plurality of clients using a homomorphic additive encryption scheme into a mask containing a matrix of values; and
sending said mask to each of said plurality of clients to be analyzed by each of said plurality of clients, wherein said verification of said trustworthiness of said aggregation scheme used in said federated learning by said aggregator is determined based on said matrix of values.

9. The computer program product as recited in claim 8, wherein said aggregator is deemed to be dishonest in response to said matrix not containing values of only a value of one.

10. The computer program product as recited in claim 8, wherein said aggregator is deemed to be honest in response to said matrix containing values of only a value of one.

11. The computer program product as recited in claim 8, wherein the program code further comprises the programming instructions for:
receiving a client's percentage of contribution of said parameters of said global model from each of said plurality of clients.

12. The computer program product as recited in claim 11, wherein the program code further comprises the programming instructions for:
determining if said aggregator is favoring one or more clients of said plurality of clients based on said received client's percentage of contribution of said parameters of said global model from each of said plurality of clients.

13. The computer program product as recited in claim 8, wherein said mask containing said matrix of values that is received by each of said plurality of clients is encrypted, wherein said mask is decrypted by each of said plurality of clients using a secret key.

14. The computer program product as recited in claim 8, wherein a first client of said plurality of clients includes falsification of one or more values in a first bit mask, wherein said falsification is detected by comparing commitments in said first bit mask with commitments provided to a trusted third party by said first client or by comparing said first bit mask with other bit masks provided by other clients pair wise.

15. A system, comprising:
a memory for storing a computer program for verifying trustworthiness of an aggregation scheme used in federated learning; and
a processor connected to said memory, wherein said processor is configured to execute program instructions of the computer program comprising:
receiving a bit mask from each of a plurality of clients used for training a machine learning algorithm using said federated learning, wherein said bit mask indicates which parameters of a global model computed by an aggregator using said federated learning correspond to parameters used by a local model trained on a client;
combining said bit masks received from said plurality of clients using a homomorphic additive encryption scheme into a mask containing a matrix of values; and
sending said mask to each of said plurality of clients to be analyzed by each of said plurality of clients, wherein said verification of said trustworthiness of said aggregation scheme used in said federated learning by said aggregator is determined based on said matrix of values.

16. The system as recited in claim 15, wherein said aggregator is deemed to be dishonest in response to said matrix not containing values of only a value of one.

17. The system as recited in claim 15, wherein said aggregator is deemed to be honest in response to said matrix containing values of only a value of one.

18. The system as recited in claim 15, wherein the program instructions of the computer program further comprise:
receiving a client's percentage of contribution of said parameters of said global model from each of said plurality of clients.

19. The system as recited in claim 18, wherein the program instructions of the computer program further comprise:
determining if said aggregator is favoring one or more clients of said plurality of clients based on said received client's percentage of contribution of said parameters of said global model from each of said plurality of clients.

20. The system as recited in claim 15, wherein said mask containing said matrix of values that is received by each of said plurality of clients is encrypted, wherein said mask is decrypted by each of said plurality of clients using a secret key.
